(19) United States
(12) Patent Application Publication
(10) Pub. No.: US 2006/0174814 A1
(43) Pub. Date: Aug. 10, 2006

(54) Meter for vehicle and combination meter incorporating the same

(75) Inventors: Takeshi Harada, Susono-shi (JP); Yoshiyuki Furuya, Susono-shi (JP); Hirokazu Yabe, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/348,227

(22) Filed: Feb. 7, 2006

(30) Foreign Application Priority Data
Feb. 7, 2005 (JP) P2005-030491
Feb. 7, 2005 (JP) P2005-030799

(51) Int. Cl. G01P 5/00

(52) U.S. Cl. 116/62.1

(57) ABSTRACT

A speedometer for a vehicle includes a display part, formed into a circular shape and that includes a movable portion rotatable about a center thereof, the movable portion having an indication design, a pointer that rotates to indicate the indication design for displaying the running speed of the vehicle. During a normal driving, the pointer rotates to indicate a position on the indication design of the movable portion that corresponds to a current running speed of the vehicle while the movable portion is fixed. During a driving with an adaptive cruse control system, the movable portion rotates so that the pointer indicates a position on the indication design of the movable portion that corresponds to the current running speed of the vehicle while the pointer is fixed.

### BACKGROUND OF THE INVENTION

The present invention relates to a speedometer for a vehicle which indicates the running speed of a vehicle by indicating an indication design provided on a dial by the use of a pointer that rotates and a combination meter which includes the speedometer.

Also, the present invention relates to a meter for a vehicle adapted to indicate a measured amount associated with a state of a vehicle by indicating an indication design provided on a dial by the use of a pointer that rotates and a combination meter which includes the meter.

In recent years, there exists an increasing tendency to equip on a vehicle such as an automobile an adaptive cruse control system which enables a constant speed driving in which the running speed of the system-equipped vehicle is kept constant by automatically accelerating and decelerating the vehicle without involving the control of accelerator and brake pedals by the driver, as well as a tracking driving in which the system-equipped vehicle follows a vehicle running in front thereof at a certain set-up distance.

For example, when the driver operates an adaptive cruse control switch to activate the system while driving normally by manipulating the accelerator and brake pedals to accelerate and decelerate the vehicle, the driving mode is shifted to the constant speed driving in which the vehicle runs autonomously at a speed corresponding to the running speed of the vehicle resulting when the switch was operated as a set-up speed, and during the autonomous driving governed by the adaptive cruse control system, the set-up speed and the running speed are compared to each other by the adaptive cruse control system, so that the running speed is made to keep matching the set-up speed by automatically controlling the throttle of an engine and brakes of the vehicle.

In adaptive cruse control system like one described above, there are known adaptive cruse control systems in which a display which displays a set-up speed and a lamp indicating an adaptive cruse control activated state is provided in a speedometer which indicates the running speed of a vehicle in order to inform the driver of running speed, set-up speed and adaptive cruse control activated state (for example, refer to JP-A-2002-274217 (page 8, FIG. 3)). In addition, there are also known adaptive cruse control systems in which two concentric pointers are provided in a speedometer which indicates the running speed of a vehicle (for example, refer to JP-A-8-334523 (pages 4 to 4, FIG. 3)).

A speedometer 81 disclosed in JP-A-2002-274217 is, as shown in FIGS. 14A, 14B, 14C, incorporated into a combination meter 80 and includes a running speed indicating scale 82 aligned into an arc-shape, a pointer 83 which indicates the scale 82 and a display 84. The display 84 has provided therein a indicator lamp 85 which indicates that a constant speed driving governed by an activated cruse control system is in operation, a display area 86 which displays a set-up speed for the constant speed driving and the like. The pointer 83 indicates an appropriate position on the scale 82 which corresponds to a running speed then of a vehicle to thereby indicate the running speed of the vehicle, and during a constant speed driving governed by the adaptive cruse control system, the indicator lamp 85 in the display 84 is illuminated, and a set-up speed is displayed in the display area 86.

A speedometer 91 disclosed in JP-A-8-334523 includes a running speed indicating scale 92 aligned into an arc-shape and two concentric pointers 93a, 93b which indicate the scale 92. During a normal driving, as shown in FIG. 15A, the two pointers 93a, 93b rotate together in a superposed state to indicated a position on the scale 92 which corresponds to a running speed then of a vehicle to thereby indicate the running speed of the vehicle. On the other hand, during a constant speed driving governed by the adaptive cruse control system, as shown in FIG. 15B, the pointer 93b is fixed in such a state that the pointer 93b indicates a position on the scale 92 which corresponds to a set-up speed to thereby indicate the set-up speed, and the pointer 93a rotates independently from the pointer 93b to indicate a position on the scale 92 which corresponds to a running speed then of the vehicle to thereby indicate the running speed of the vehicle.

In the speedometer 81 disclosed in JP-A-2002-274217, however, the exclusive display 84 is necessary which includes the display area 86 for displaying a set-up speed and the indicator lamp 85 for indicating that a constant speed driving governed by the adaptive cruse control system is in operation, and this produces a concern about a cost increase.

In the speedometer 91 disclosed in JP-A-8-334523, while the activation of a constant speed driving governed by the adaptive cruse control system is designed to be visually recognized through a deviation in position between the pointer 93b which is fixed to indicate a set-up speed for the constant speed driving and the pointer 93a which rotates independently from the pointer 93b to indicate the running speed of the vehicle, since the deviation in position between the two pointers 93a, 93b is small due to a change in speed during the constant speed driving governed by the adaptive cruse control system being small, that is, the amplitude of the pointer 93b which indicates the running speed of the vehicle being relatively small, the visibility of the speedometer on the activation of the constant speed driving governed by the adaptive cruse control system cannot be sufficient, and additionally, there has been an inherent risk that it is not possible to momentarily determine which pointer indicates which speed; the running speed or the set-up speed.

Furthermore, while it has been a common practice that the adaptive cruse control systems are used in a high-speed range where the running speed ranges from 60 to on the order of 100 km/h, in recent years, they have come to be used in a low-speed range where the running speed decreases to 30 km/h or lower. In these circumstances, since divisions of the scale which indicate running speeds in the low-speed range are generally disposed in a lower area of the speedometer, the pointer always has to point towards the lower area of the speedometer during the constant speed driving in the low-speed range governed by the adaptive cruse control, and since this causes the driver to move his or her line of sight relatively largely from the front of the vehicle to the position indicated by the pointer, the driver's load is increased, leading to a risk that the visibility of the speedometer is deteriorated on indication of the occurrence of the constant speed driving governed by the adaptive cruse control system.

Further, a combination meter is equipped on a vehicle such as the automobile on which a plurality of meters and gauges are provided which indicate various measured amounts associated with a state of the vehicle such as running speed, engine speed, residual fuel amount, coolant temperature and the like. Furthermore, in recent years, there is an increasing tendency to provide within the combination meter a multi-display which displays various warnings and other pieces information which are associated with the state of the vehicle.

In these situations, since the meters and gauges which are adapted to indicate various measured amounts are disposed independently from one another, occupying a relatively large space on the combination meter, there has been imposed a limitation on a space to dispose the multi-display.

Then, there has been proposed a meter for the vehicle in which a single meter is adapted to indicate a plurality of measured amounts so as to reduce a space occupied thereby (for example, refer to JP-A-2004-219210).

A meter 201 disclosed in JP-A-2004-219210 includes, as shown in FIG. 16, a flat plate-shaped dial 203 having an analog area including first and second indication designs 202a, 202b which correspond to running speed and engine speed in revolution, respectively, a long pointer 204 which indicates the first indication design 202a, and a short pointer 205 which indicates the second indication design 202b, and a first rotating shaft on which the long pointer 204 is mounted and a second rotating shaft on which the short pointer 205 is mounted are disposed in such a manner as to coincide with each other, whereby the running speed of the vehicle is designed to be indicated by the first indication design 202a and the long pointer 204, whereas the engine speed in revolution is designed to be indicated by the second indication design 202b and the short pointer 205.

According to the meter disclosed in JP-A-2004-219210, while the plurality of measured amounts can be indicated within the occupied space which is smaller than those of the other related-art meters, there has existed an inherent risk that the driver fails to properly recognize the indication designs indicated by the respective pointers 204, 205, a measure for enhancing the visibility of the meter having thereby been demanded.

### SUMMARY OF THE INVENTION

The invention was made in these situations and an first object thereof is to provide for low cost a speedometer which provides a superior visibility on information delivered to the driver on running speed, set-up speed and adaptive cruse control activated state.

Also, a second object of the invention is to provide a meter for a vehicle which can reduce a space occupied thereby compared to those by the related-art meters while indicating a plurality of measured amounts and which has a superior visibility, as well as a combination meter including the meter.

With a view to attaining the objects, the invention provides a speedometer which is characterized as will be described under (1) to (6) below.

(1) According to a first aspect of the invention, there is provided a speedometer for a vehicle, comprising:
a display part formed into a circular shape and that includes a movable portion rotatable about a center thereof, the movable portion having an indication design; and
a pointer that rotates to indicate the indication design for displaying the running speed of the vehicle,
wherein during a normal driving, the pointer rotates to indicate a position on the indication design of the movable portion that corresponds to a current running speed of the vehicle while the movable portion is fixed; and
wherein during a driving with an adaptive cruse control system, the movable portion rotates so that the pointer indicates a position on the indication design of the movable portion that corresponds to the current running speed of the vehicle while the pointer is fixed.

(2) Preferably, the pointer is fixed in a state that the pointer is directed perpendicularly upwardly during the driving with the adaptive cruse control system.

According to the speedometer set forth under (1) above, the indication modes of the running speed of the vehicle are different between during the normal driving and during the driving with the adaptive cruse control system engaged, whereby the visibility thereof on indication of the adaptive cruse control activated state can be enhanced. In addition, since a change in speed is small during a constant speed driving governed by the adaptive cruse control system, the set-up speed can substantially be known from the indicated running speed, and therefore, no exclusive display is necessary which displays a set-up speed and indicates that the driving governed by the adaptive cruse control system is in operation, thereby making it possible to realize a reduction in production costs of the speedometer.

According to the automotive speedometer set forth under (2) above, since the pointer is fixed in such a state that the pointer is directed perpendicularly upwardly to indicate an upper area of the speedometer during the driving with the adaptive cruse control system engaged, a distance can be reduced over which the line of sight of the driver is shifted from the front of the vehicle to the position indicated by the pointer, thereby making it possible to reduce load borne by the driver so as to enhance the visibility thereof on indication of the adaptive cruse control activated state.

In addition, according to the invention, there is provided a combination meter as set forth under (3) below.

According to the invention, there is provided a combination meter which includes the speedometer set forth under (1) or (2) above.

According to the speedometer of the invention, it becomes possible to realize an enhancement in visibility of the speedometer which delivers information to the driver on running speed, set-up speed and adaptive cruse control activated state, as well as a reduction in production costs.

(4) According to a second aspect of the invention, there is provided a meter for a vehicle, comprising:
a display part that includes:
   a stationary portion having a first indication design for a first measured amount associated with a state of the vehicle; and
   a movable portion having a second indication design for a second measured amount associated with the state of the vehicle, the movable portion disposed concentrically with the stationary portion and adapted to rotate about a center of the stationary portion; and
a pointer that rotates to indicate a position on the first indication design of the stationary portion that corresponds to the first measured amount,
wherein the movable portion rotates so that the pointer indicates a position on the second indication design of the movable portion that corresponds to the second measured amount; and
wherein the second measured amount is different from the first measured amount.

(5) Preferably, the pointer is fixed in a state that the pointer is directed perpendicularly upwardly during the driving with the adaptive cruse control system.

According to the automotive meter set forth under (4) above, the pointer rotates in such a manner as to indicate the position on the first indication design provided on the stationary portion of the display part which corresponds to the first measured amount, and the movable portion rotates in such a manner as to locate the position on the second indication design provided on the movable portion of the display part which corresponds to the second measured amount in the direction indicated by the pointer that has so rotated to thereby indicate the second measured amount. Thus, since the plurality of measured amounts are indicated by the single pointer, there can be eliminated the risk, which occurs when a plurality of pointers are used, that the driver fails to properly recognize which pointer indicates which indication design, and a distance over which the line of sight of the driver is shifted can be reduced compared to the case where the meters and gauges are disposed independently from one another to indicate individual measured amounts, whereby the visibility of the meter can be enhanced. In addition, since the plurality of measured amounts are indicated by the single meter, the space occupied by the meter can be reduced compared to the case where the meters and gauges are disposed independently from one another to indicate individual measured amounts.

According to the automotive meter set forth under (5) above, since the gauge is provided on the stationary portion of the display part which indicates the measured amount associated with the state of the vehicle which is different from the first and second measured amounts, the space occupied by the meter can be reduced further.

In addition, according to the invention, there is provided a combination meter as set forth under (6) below.

(6) According to the invention, there is provided a combination meter which includes the meter set forth under (4) or (5) above.

According to the meter and the combination meter including the meter of the invention, the space occupied by the meter can be reduced compared to those by the related-art meters while indicating a plurality of measured amounts and the visibility of the meter can be enhanced.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 shows a front view of a first embodiment of an automotive speedometer according to the invention;

FIG. 2 shows a sectional view of the speedometer shown in FIG. 1;

FIG. 3 shows a front view which explains an operation of the speedometer shown in FIG. 1 during normal driving;

FIG. 4 shows a front view which explains an operation of the speedometer shown in FIG. 1 during a driving with an adaptive cruse control system engaged;

FIG. 5 shows a front view of a combination meter into which the speedometer shown in FIG. 1 is incorporated;

FIG. 6 shows a drawing relating to a modified example of the speedometer shown in FIG. 1, which is a front view of a combination meter into which the modified speedometer is incorporated;

FIG. 7 shows a front view of a second embodiment of an automotive meter according to the invention;

FIG. 8 shows a sectional view of the automotive meter shown in FIG. 7;

FIG. 9 shows a block diagram which explains a control system of the automotive meter shown in FIG. 7;

FIG. 10 shows a front view which explains an operation of the automotive meter shown in FIG. 7;

FIG. 11 shows a front view of a combination meter into which the automotive meter shown in FIG. 7 is incorporated;

FIG. 12 shows a front view of a third embodiment of an automotive meter according to the invention;

FIG. 13 shows a front view of a combination meter into which the automotive meter shown in FIG. 12 is incorporated;

FIG. 14A shows a front view of a combination meter into which the related speedometer is incorporated;

FIG. 14B shows an enlarged view of a main part of the related speedometer shown in FIG. 14A;

FIG. 14C shows a schematic front view of the related speedometer shown in FIG. 14A;

FIG. 15A shows a perspective view and a front view of the another related speedometer during normal driving;

FIG. 15B shows a perspective view and a front view of the another related speedometer during a driving with an adaptive cruse control system engaged; and

FIG. 16 shows a front view of an automotive meter according to the related art.

### DETAILED DESCRIPTION OF THE PREFERRED EMBODIMENTS

Hereinafter, a preferred embodiments according to the invention will be described in detail based on the drawings.

### FIRST EMBODIMENT

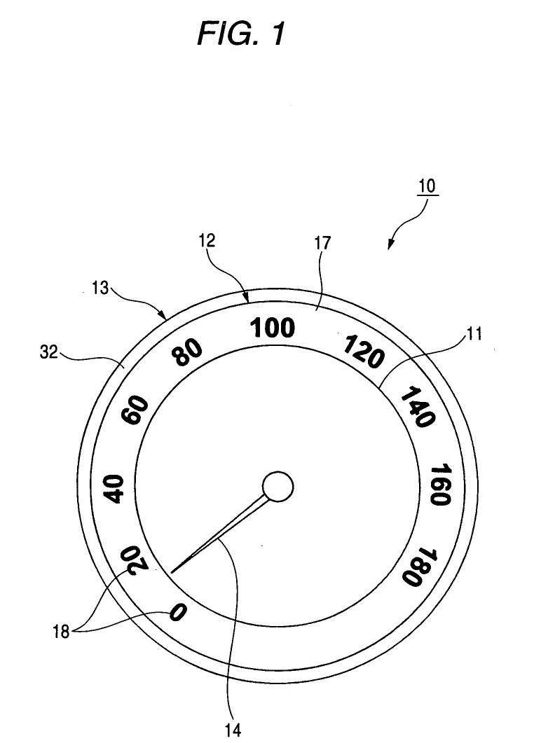

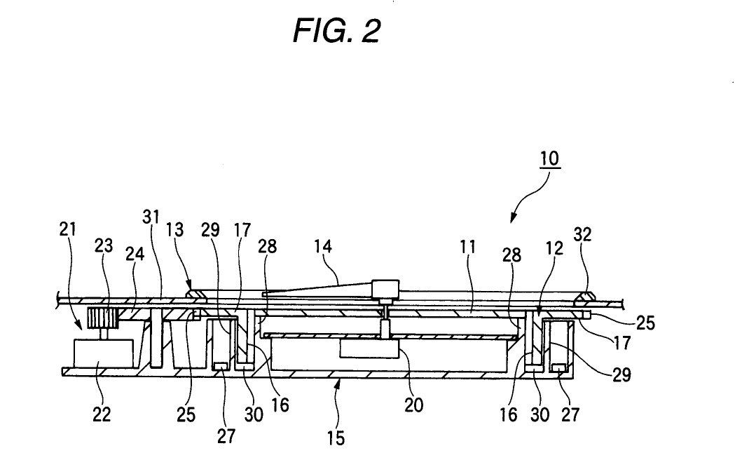

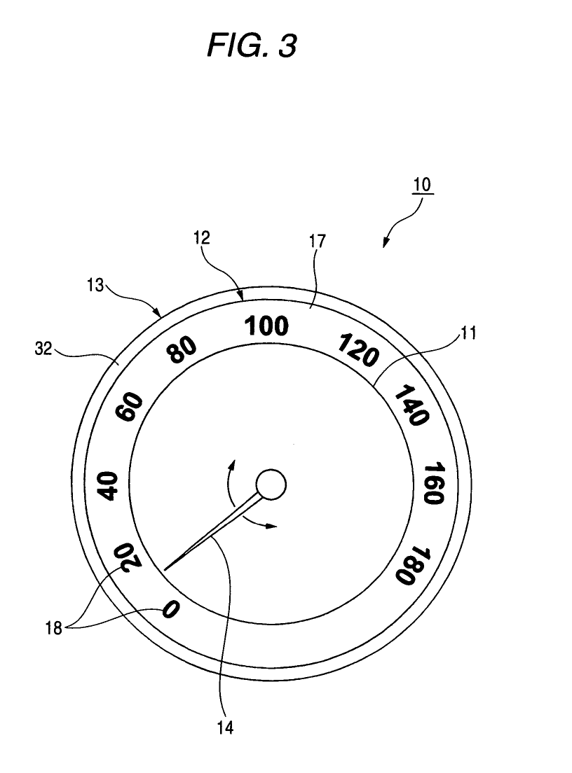

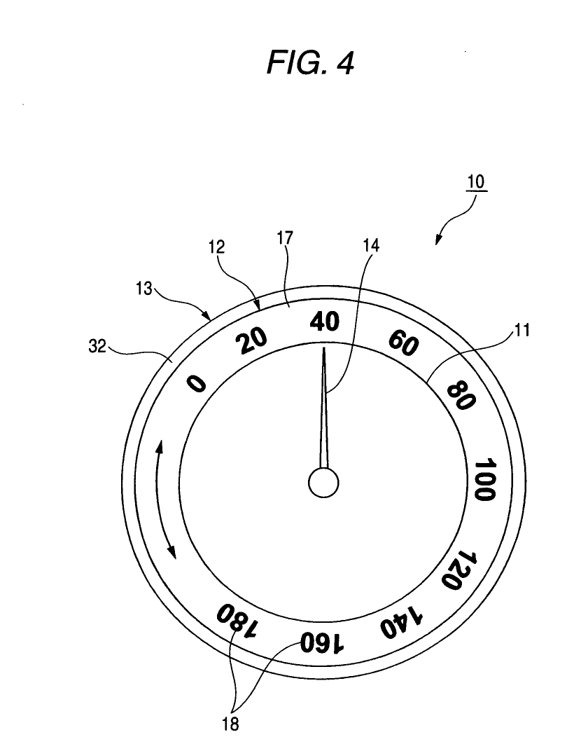

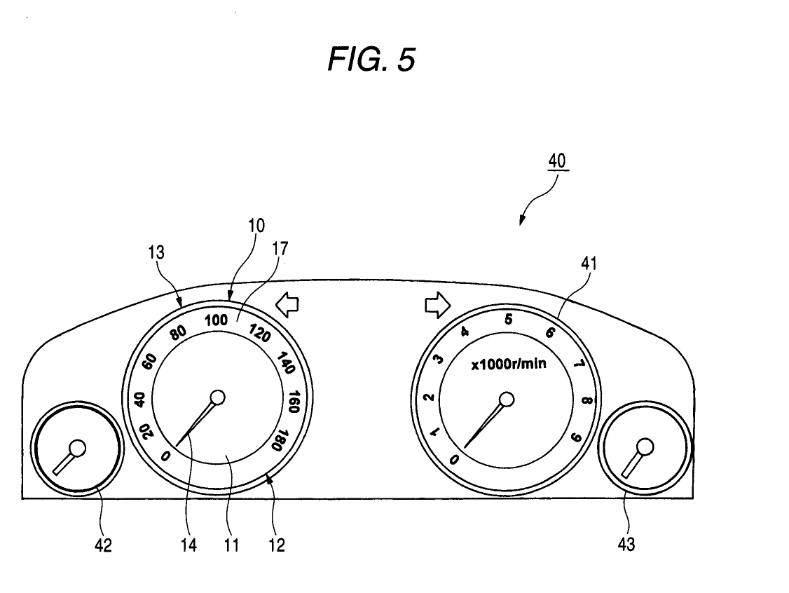

FIG. 1 is a front view of a first embodiment of an automotive speedometer according to the invention, FIG. 2 is a sectional view of the speedometer shown in FIG. 1, FIG. 3 is a front view which explains an operation of the speedometer shown in FIG. 1 during a normal driving, FIG. 4 is a front view which explains an operation of the speedometer shown in FIG. 1 during a driving with an adaptive cruse control system engaged, and FIG. 5 is a front view of a combination meter into which the speedometer shown in FIG. 1 is incorporated.

A speedometer 10 of this embodiment is a so-called analog type of speedometer in which the running speed of a vehicle is indicated by indicating an indication design provided on a dial by the use of a pointer that rotates and is, as shown in FIG. 5, incorporated into a combination meter 40 equipped on a vehicle such an automobile.

A plurality of instruments for indicating various pieces of information on a state of a vehicle such as running speed, engine speed, residual fuel amount, coolant temperature and the like are provided on this combination meter 40, and the speedometer 10 which indicate the running speed of a vehicle is provided at a position which is slightly leftward of the central portion of the combination meter 40, whereas a tachometer 41 which indicates the speed of an engine in revolution is provided at a position slightly rightward of the central portion. In addition, for example, a fuel gauge 42 which indicates a residual amount of fuel is provided to the left of the speedometer 10, whereas a coolant temperature gauge 43 which indicates the temperature of a coolant is provided to the right of the tachometer 41. Furthermore, a multi-display which displays various warnings can be provided on the combination meter 40.

On the combination meter 40, which is configured as described above, facing members which divide a dial are disposed on a front side of the dial on which indication designs are provided which constitute indices of running speed, engine speed, residual fuel amount, coolant temperature and the like in such a manner as to correspond to the speedometer 10, the tachometer 41, the fuel gauge 42, the coolant temperature gauge 43 and the like, and a transparent cover is mounted on a front side of the facing members. In contrast, a case which supports the dial is provided on a rearward side of the dial, and the case is configured to accommodate therein a liquid crystal display which makes up a multi-display, a light source such as LED which illuminates the dial from the rearward side thereof, driving devices which drive pointers of the speedometer 10, the tachometer 41, the fuel gauge 42, the coolant temperature gauge 43 and the like, respectively, and a wiring board on which a control circuit is provided which controls the liquid crystal display, the illumination device, the driving devices and the like.

As shown in FIGS. 1 and 2, the speedometer 10 has a circular stationary portion 11 which is fixedly supported on a frame 28 of the case 15 and a circular ring-shaped movable portion 12 which is disposed concentrically with the stationary portion 11 on an outer circumferential side of the stationary portion 11 and is adapted to rotate about a center of the stationary portion 11 in an area which is defined into a circular shape by a decorative design ring 32 of a facing member 13. In addition, the speedometer 10 has on the stationary portion 11 of the dial a pointer 14 which is driven to rotate about the center of the stationary portion 11 by a driving device 20 accommodated in the case 15.

The movable portion 12 of the dial has a flat plate-shaped flange portion 17 which is flush with the stationary portion 11 and a cylindrical portion 16 which is provided from an inner circumferential edge of the flange portion 17 in such a manner as to erect towards the case 15 side and is formed, as a whole, into a circular ring shape having an L-shaped section.

The cylindrical portion 16 of the movable portion 12 is accommodated in a circular ring-shaped accommodating space 30 defined between the frame 28 of the case 15 which fixedly supports the stationary portion 11 of the dial and a frame 29 provided on an outer circumferential side of the frame 28, and the movable portion 12 is rotatably supported on the case 15 by, for example, interposing rolling elements between an outer circumferential surface of the cylindrical portion 16 and an inner circumferential surface of the frame 29.

Figures such as “0”, “20”, “40”, “60”, “80”, “120”, “140”, “160” and “180” are aligned into an arc-like shape on the flange portion 17 of the movable portion 12 as an indication design 18 which indicates the running speed of a vehicle. The flange portion 17 excluding portions thereof where the indication design 18 is provided or the portions of the flange portion 17 where the indication design 18 is provided have a light transmitting property and are designed to be illuminated in the color of illumination light from a light source 27 disposed on a rearward side thereof by being lit by the illumination light. In addition, teeth 25 are provided on an outer circumferential edge of the flange portion 17 in such a manner as to mesh with a gearwheel 24 of a driving mechanism 21, which will be described later on, and the movable portion 12 is driven to rotate by this driving mechanism 21.

The driving mechanism 21 has a driving device 22 accommodated in the case 15, a first gearwheel 23 connected to a rotating shaft of the driving device 22 and the second gearwheel 24 which is rotatably supported on the case 15 and is adapted to mesh with the first gearwheel 23. The first gearwheel 23 and the second gearwheel 24 make up a reduction gear or speed reducing mechanism having a predetermined reduction gear ratio, and the movable portion 12 of the dial is driven by the driving device 22 via this speed reducing mechanism. Note that the driving mechanism 21 is covered by a shielding portion 31 of the facing member 13.

As the driving device 22 and the driving device 20 which drives the pointer 14, for example, a stepping motor can be used which can control its rotating angle in both normal or forward and backward directions. In addition, for example, a DC motor can also be used which has no control function to control its rotating angle. In this event, a rotating angle sensor such as an encoder is used to detect the rotating angle of the arbitrary rotating element (the movable portion 12, the gearwheels 23, 24, and the like) to control the rotating angle based on an output of the sensor.

Next, the operation of the speedometer 10 that is configured as has been described above will be described by taking as an example a constant speed driving governed by the adaptive cruse control system.

Firstly, as shown in FIG. 1, the movable portion 12 of the dial is fixed in such a state that the figure “0” of the indication design 18 is situated in a lower area of the speedometer 10, and the driving device 20 receives an output from the control circuit provided on the wiring board on the combination meter 40 in accordance with a detected running speed of the vehicle and so drives the pointer 14, whereby the pointer 14 rotates to indicate a position on the indication design 18 provided on the movable portion 12 of the dial which corresponds to the detected running speed of the vehicle to thereby indicate the detected running speed of the vehicle.

When the driving mode is shifted from the normal driving to a constant speed driving governed by the adaptive cruse control system, the running speed of the vehicle resulting when the normal driving is shifted to the constant speed driving is set as a set-up speed. Then, the driving device 20 receives an output from the control circuit provided on the wiring board on the combination meter 40 and drives the pointer 14 to rotate until the pointer 14 is directed perpendicularly upwardly, as shown in FIG. 4, where the pointer 14 is fixed in such a state. At the same time, the driving device 22 receives an output from the control circuit provided on the wiring board on the combination meter 40 and drives the movable portion 12 of the dial, whereby the movable portion 12 is caused to rotate to locate a position on the indication design 18 which corresponds to a running speed then of the vehicle to a position indicated by the pointer 14 to thereby indicate the running speed of the vehicle.

During the constant speed driving governed by the adaptive cruse control system, while the set-up speed and the running speed are compared by the adaptive cruse control system, so that the throttle of the engine and the brakes are automatically controlled so as to keep the running speed at the set-up speed, in the event that there is caused a slight change in speed when, for example, the vehicle is climbing up along a slope, the driving device 22 receives an output from the control circuit provided on the wiring board on the combination meter 40 in accordance with a detected running speed of the vehicle and so drives the movable portion 12 on the dial, whereby the movable portion 12 is caused to rotate to locate a position on the indication design 18 which corresponds to the detected running speed to a position indicated by the pointer 14 to thereby indicate the running speed of the vehicle as appropriately.

Note that during the constant speed driving governed by the adaptive cruse control system, the light source 27 is switched on, and the light transmitting flange portion 17 excluding the portions where the indication design 18 is provided or the light transmitting portions of the flange portion 17 where the indication design 18 is provided receive light from the light source 27 and are then illuminated in the color of the light so received.

According to the speedometer 10 of the first embodiment of the invention, while during the normal driving, the pointer 14 rotates to indicate a position on the indication design 18 provided on the movable portion 12, which is being fixed, on the dial which corresponds to a running speed then of the vehicle to thereby indicate the running speed of the vehicle, during the driving governed by the adaptive cruse control system, the movable portion 12 of the dial is caused to rotate to locate a position on the indication design 18 provided on the movable portion 12 which corresponds to a running speed then of the vehicle to a position indicated by the pointer 14 to thereby indicate the running speed of the vehicle. Thus, the indication modes of running speed are different between during the normal driving and during the driving governed by the adaptive cruse control system, thereby making it possible to enhance the visibility of the speedometer on the indication that the driving governed by the adaptive cruse control system is in operation. In addition, since the change in speed is small during the constant speed driving governed by the adaptive cruse control system, the set-up speed can substantially be known from the indicated running speed, whereby no exclusive display is necessary which displays a set-up speed and indicates an adaptive cruse control activated state, thereby making it possible to realize a reduction in production cost of the speedometer 10.

In addition, since the pointer 14 is fixed in such a state that the pointer 14 is directed perpendicularly upwardly to indicate the upper area of the speedometer 10, the distance can be reduced over which the line of sight of the driver is shifted from the front of the vehicle to the position indicated by the pointer 14, whereby load borne by the driver is reduced, thereby making it possible to enhance the visibility of the speedometer 10 on indication of the occurrence of the constant speed driving governed by the adaptive cruse control system.

Furthermore, during the driving governed by the adaptive cruse control system, the light source 27 is switched on, and the light transmitting flange portion 17 excluding the portions where the indication design 18 is provided or the light transmitting portions of the flange portion 17 where the indication design 18 is provided receive the light from the light source 27 so as to be illuminated in the color of the light, whereby a change in indication mode of running speed from the normal driving to the driving governed by the adaptive cruse control system becomes conspicuous, thereby making it possible to enhance the visibility of the speedometer 10 on indication of the adaptive cruse control activated state.

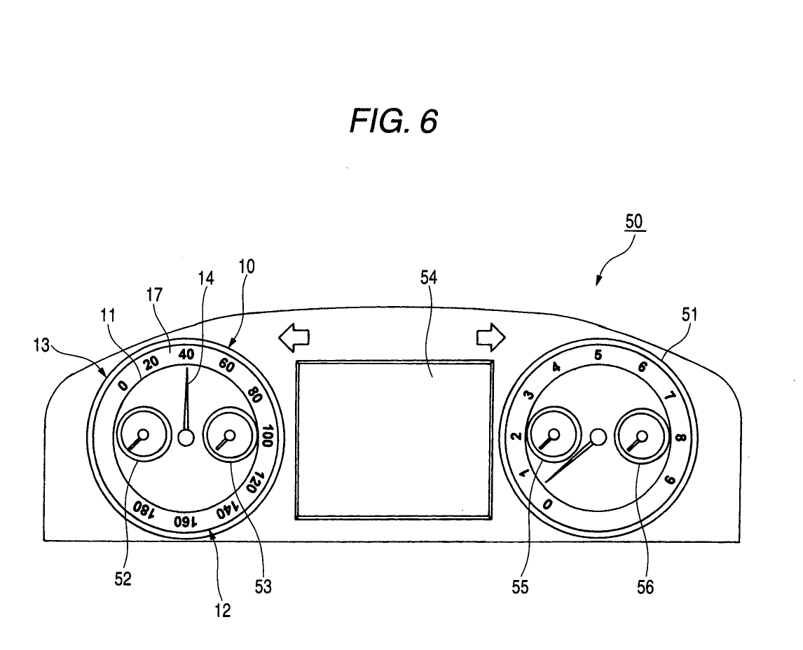

Next, referring to FIG. 6, a modification to the speedometer 10 described above will be described.

FIG. 6 is a front view of a combination meter into which a modified example to the speedometer 10 shown in FIG. 1 is incorporated.

As shown in FIG. 6, a speedometer 10′ according to the modified example is a so-called chronograph-like speedometer in which indication designs for, for example, a fuel gauge 52 and a coolant temperature gauge 53 are provided on a front side of a stationary portion 11 on a dial, pointers indicating the indication designs of the fuel gauge 52 and the coolant temperature gauge 53 are provided on the front side of the stationary portion 11, and driving devices driving the pointers of the fuel gauge 52 and the coolant temperature gauge 53 are provided on a rearward side of the stationary portion 11. According to this speedometer 10′, spaces for indicating running speed, residual fuel amount and coolant temperature are reduced, whereby space on a combination meter 50 into which the speedometer 10′ is incorporated can be utilized effectively. In the combination meter 50 shown in FIG. 6, other gauges 55, 56 are incorporated also in a tachometer 51, whereby an extra space is produced on the combination meter 50, where a multi-display 54 is provided.

### SECOND EMBODIMENT

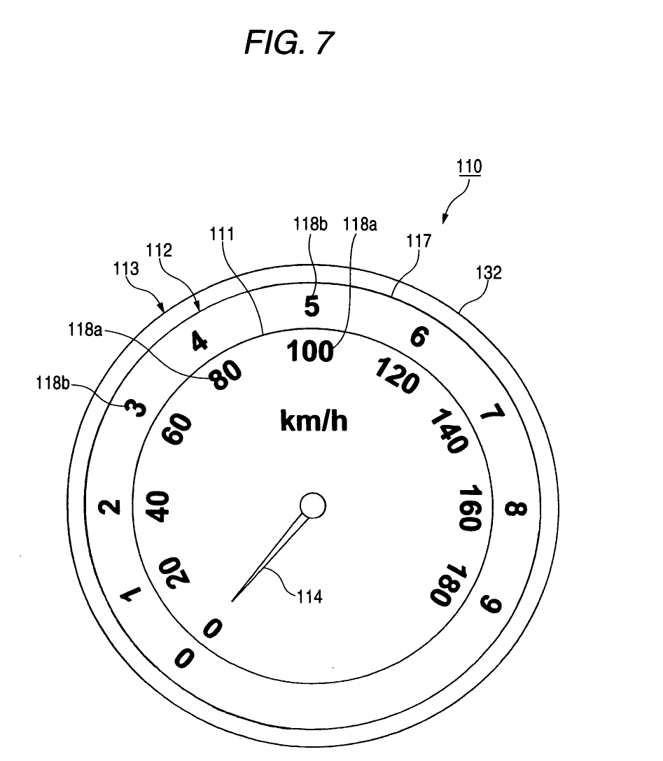

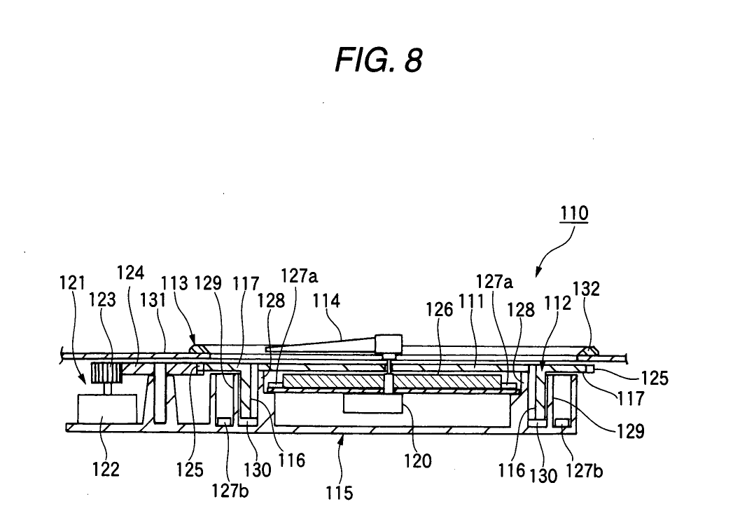

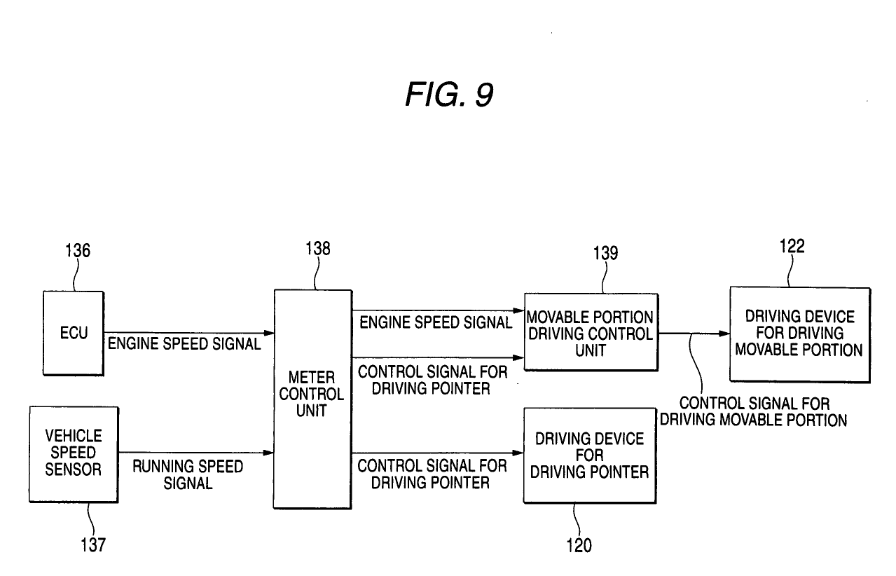

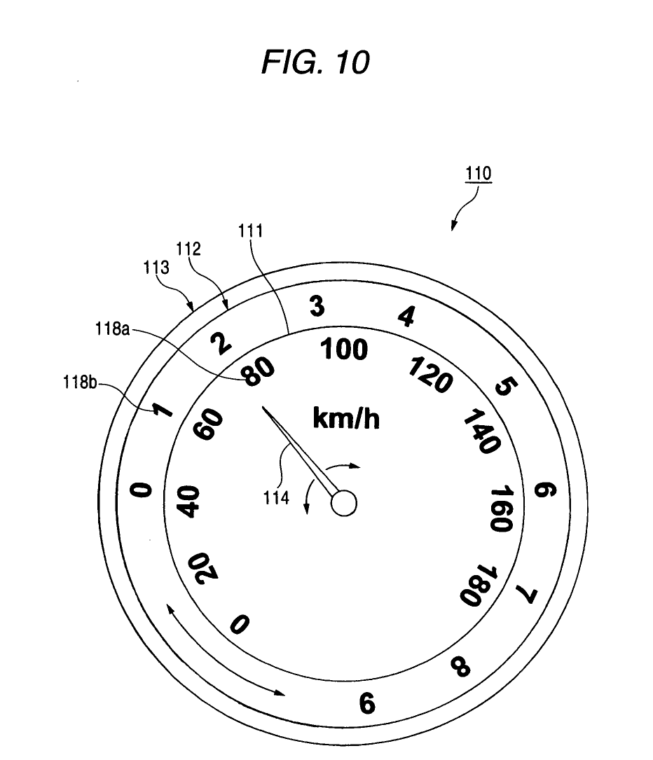

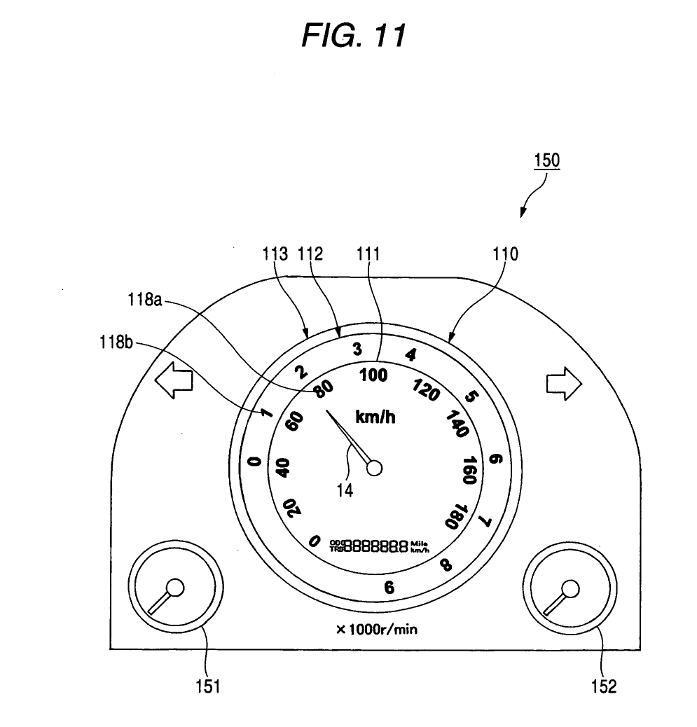

FIG. 7 is a front view of a second embodiment of an automotive meter according to the invention, FIG. 8 is a sectional view of the automotive meter shown in FIG. 7, FIG. 9 is a block diagram which explains a control system of the automotive meter shown in FIG. 7, FIG. 10 is a front view which explains an operation of the automotive meter shown in FIG. 7, and FIG. 11 is a front view of a combination meter into which the automotive meter shown in FIG. 7 is incorporated.

An automotive meter 110 of this embodiment is a so-called analog type of meter in which a measured amount associated with a state of a vehicle is indicated by indicating an indication design provided on a dial by the use of a pointer that rotates and is, as shown in FIG. 11, incorporated into a meter cluster or combination meter 140 equipped on a vehicle such as an automobile.

A plurality of instruments for indicating various pieces of information on a state of a vehicle such as running speed, engine speed, residual fuel amount, coolant temperature and the like are provided on this combination meter 150, and the speedometer 110 which indicates the running speed of the vehicle and the speed of an engine in revolution is provided at a central portion of the combination meter 150, and a fuel gauge 151 which indicates a residual fuel amount is to the left of the speedometer 110, whereas a coolant temperature gauge 54 which indicates the temperature of a coolant is provided to the right of the meter 110. In addition, a multi-display which displays various warnings can be provided on the combination meter 150.

On the combination meter 150, which is configured as described above, facing members which divide a dial are disposed on a front side of the dial on which indication designs are provided which constitute indices of running speed, engine speed, residual fuel amount, coolant temperature and the like in such a manner as to correspond to the meter 110, the fuel gauge 151, the coolant temperature gauge 152 and the like, and a transparent cover is mounted on a front side of the facing members. In contrast, a case which supports the dial is provided on a rearward side of the dial, and the case is configured to accommodate therein a liquid crystal display which makes up a multi-display, a light source such as LED which illuminates the dial from the rearward side thereof, driving devices which drive pointers of the speedometer 110, the fuel gauge 151, the coolant temperature gauge 152 and the like, respectively, and a wiring board on which a control circuit is provided which controls the liquid crystal display, the illumination device, the driving devices and the like.

As shown in FIGS. 1 and 2, the meter 110 has a disc-shaped stationary portion 111 which is fixedly supported on a frame 128 of the case 115 and a circular ring-shaped movable portion 112 which is disposed concentrically with the stationary portion 111 on an outer circumferential side of the stationary portion 111 and is adapted to rotate about a center of the stationary portion 111 in an area which is defined into a circular shape by a decorative design ring 132 of a facing member 113. In addition, the meter 110 has on the stationary portion 111 of the dial a pointer 114 which is driven to rotate about the center of the stationary portion 111 by a driving device 120 accommodated in the case 115.

Figures such as “0”, “20”, “40”, “60”, “80”, “100”, “120”, “140”, “160” and “180” are aligned about the center of the stationary portion 111 into an arc-like shape on the stationary portion 111 of the dial as a first indication design 118a which indicates running speed which constitutes a first measured amount, and characters are provided substantially at a central portion of the first indication design to indicate a unit of running speed, “Km/h”. Portions where the first indication design 118a is provided have a light transmitting property and light from a light source 127a disposed on a rearward side thereof is emitted thereto via a light guiding member 126, so that the portions are designed to be illuminated in an illumination color of the light source 127a.

The movable portion 112 of the dial has a flat plate-shaped flange portion 117 which is flush with the stationary portion 111 and a cylindrical portion 116 which is provided from an inner circumferential edge of the flange portion 117 in such a manner as to erect towards the case 115 side and is formed, as a whole, into a circular ring shape having an L-shaped section.

The cylindrical portion 116 of the movable portion 112 is accommodated in a circular ring-shaped accommodating space 130 defined between the frame 128 of the case 115 which fixedly supports the stationary portion 111 of the dial and a frame 129 provided on an outer circumferential side of the frame 128, and the movable portion 112 is rotatably supported on the case 115 by, for example, interposing rolling elements between an outer circumferential surface of the cylindrical portion 116 and an inner circumferential surface of the frame 129.

Figures such as “0”, “1”, “2”, “3”, “4”, “5”, “6”, “7”, “8” and “9” are aligned about the center of the stationary portion 111 into an arc-like shape on the flange portion 117 of the movable portion 112 as a second indication design 118b which indicates engine speed in revolution which constitutes a second measured amount. These figures constitute indices of the speed of the engine of the vehicle in revolution per minute based on the understanding that each figure is multiplied by 1000 to indicate an actual engine speed per minute or is followed by “×1000 r/min”. The flange portion 117 excluding portions thereof where the indication design 118b is provided or the portions of the flange portion 117 where the indication design 118b is provided have a light transmitting property and are designed to receive light from a light source 127b disposed on a rearward side thereof to thereby be illuminated in an illumination color of the light source 127. Note that in order to enhance the visibility of the meter, different colors are preferably used for the illumination colors of the light source 127a and the light source 127b. In addition, teeth 125 are provided on an outer circumferential edge of the flange portion 117 in such a manner as to mesh with a gearwheel 124 of a driving mechanism 121, which will be described later on, and the movable portion 112 is driven to rotate by this driving mechanism 121.

The driving mechanism 121 has a driving device 122 accommodated in the case 115, a first gearwheel 123 connected to a rotating shaft of the driving device 122 and the second gearwheel 124 which is rotatably supported on the case 115 and is adapted to mesh with the first gearwheel 123. The first gearwheel 123 and the second gearwheel 124 make up a reduction gear or speed reducing mechanism having a predetermined reduction gear ratio, and the movable portion 112 of the dial is driven by the driving device 122 via this speed reducing mechanism. Note that the driving mechanism 121 is covered by a shielding portion 131 of the facing member 113.

As the driving device 122 and the driving device 120 which drives the pointer 114, for example, a stepping motor can be used which can control its rotating angle in both normal or forward and backward directions.

A control system of the meter 110 is shown in FIG. 9.

A control circuit provided on a wiring board of the combination meter 150 includes a meter control unit 138 and a movable portion driving control unit 139. An engine speed signal outputted from an engine control unit (ECU) 136 in accordance with the speed of the engine in revolution and a running speed signal outputted from a vehicle speed sensor 137 provided on the vehicle in accordance with the running speed of the vehicle are inputted into the meter control unit 138.

The meter control unit 138 calculates a rotating angle of the pointer 114 based on the running speed signal so inputted, so that the pointer 114 indicates a position on the first indication design 118 provided on the stationary portion 111 of the dial which corresponds to a running speed then of the vehicle, and sends out a pointer driving control signal in accordance with the result of the calculation to the driving device 120. In addition, the meter control unit 138 sends out an engine speed signal and the pointer driving control signal to the movable portion driving control unit 139.

The movable portion driving control unit 139 calculates a rotating angle of the pointer 114 from the pointer driving control signal so inputted and calculates a rotating angle of the movable portion based on the rotating angle of the pointer 114 and the engine speed, so that a position on the second indication design 118b provided on the movable portion 112 of the dial which corresponds to an engine speed then is located to the direction indicated by the pointer, sending out a movable portion driving control signal in accordance with the result of the calculation to the driving device 122.

The driving device 120 drives the pointer 114 based on the pointer driving control signal inputted thereinto. In addition, the driving device 122 drives the movable portion 112 based on the movable portion driving control signal inputted thereinto. Note that in the event that for example, a DC motor having no function to control the rotating angle thereof is used as the driving device 122 and the driving device 120, a rotating angle sensor such as an encoder is used to detect an actual rotating angle of the arbitrary rotating element (the movable portion 112, the pointer, the gearwheels 123, 124 and the like), and this sensor output is fed back to the meter control unit 138 and the movable portion driving control unit 139 for calculation of rotating angles of the pointer 114 and the movable portion 112.

Next, an operation of the automotive meter 110 configured as has been described heretofore will be described.

Firstly, in a state where the vehicle is stopped, as shown in FIG. 7, the pointer 114 is in such a state as to indicate the figure “0” of the first indication design 118a provided on the stationary portion of the dial, and the movable portion 112 of the dial is in such a state that the figure “0” of the second indication design 118b is disposed in the direction indicated by the pointer 114.

As the vehicle runs, as shown in FIG. 10, the driving device 120 drives the pointer 114 based on the pointer driving control signal inputted thereinto, whereby the pointer 114 is caused to rotate to indicate a position on the first indication design 118a provided on the stationary portion 111 of the dial which corresponds to a running speed then of the vehicle to thereby indicate the running speed of the vehicle.

In synchronism with this, the driving device 122 drives the movable portion 112 of the dial via the gearwheels 123, 124 based on the movable portion driving control signal inputted thereinto, whereby the movable portion 112 is caused to rotate to locate a position on the second indication design 118b provided on the movable portion 112 of the dial which corresponds to an engine speed then in the direction indicated by the pointer 114 to thereby indicate the speed of the engine in revolution.

According to the automotive meter 110 of the first embodiment of the invention, the pointer 114 rotates in such a manner as to indicate the position of the first indication design 118a provided on the stationary portion 111 of the dial which corresponds to the running speed then of the vehicle to thereby indicate the running speed of the vehicle, and at the same time the movable portion 112 rotates in such a manner as to locate the position on the second indication design 118b provided on the movable portion 112 of the dial which corresponds to the engine speed then in the direction indicated by the pointer 114 that has so rotated to thereby indicate the speed of the engine in revolution. Thus, since the plurality of measured amounts are indicated by the single pointer 114, there can be eliminated the risk, which occurs when a plurality of pointers are used, that the driver fails to properly recognize which pointer indicates which indication design, and a distance over which the line of sight of the driver is shifted can be reduced compared to the case where the meters and gauges are disposed independently from one another to indicate individual measured amounts, whereby the visibility of the meter can be enhanced. In addition, since the plurality of measured amounts are indicated by the single meter, the space occupied by the meter can be reduced compared to the case where the meters and gauges are disposed independently from one another to indicate individual measured amounts.

### THIRD EMBODIMENT

Next, referring to FIGS. 6 and 7, a modification of the composite meter 110 will described.

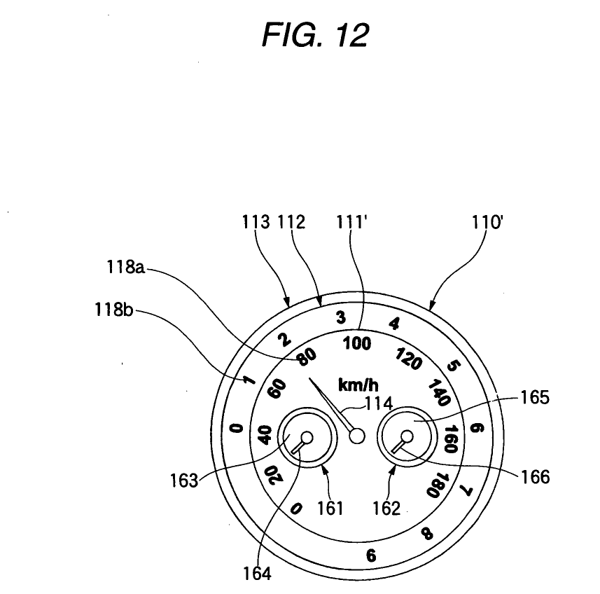

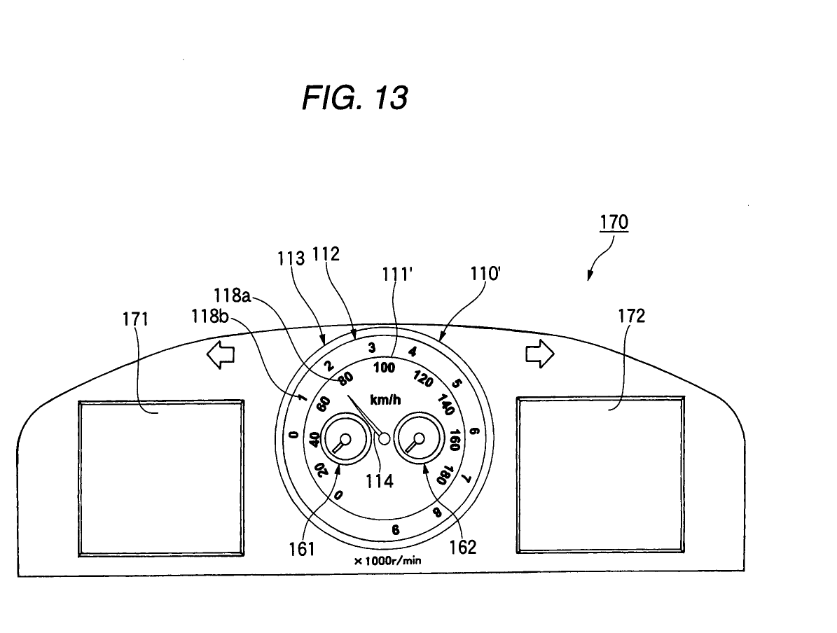

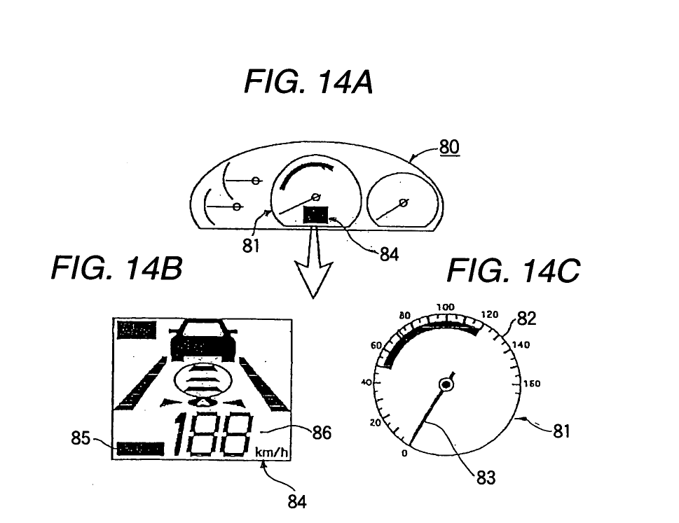

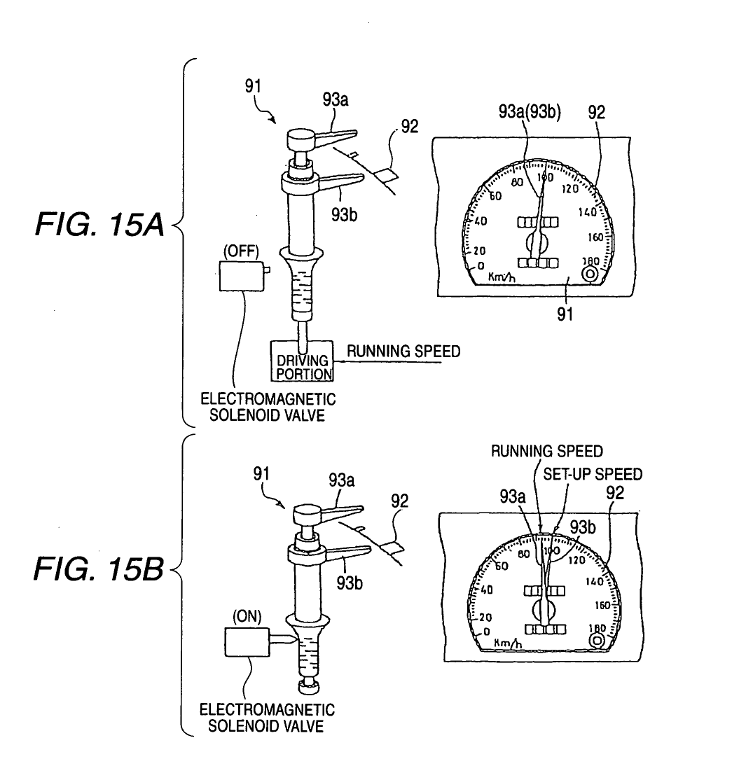

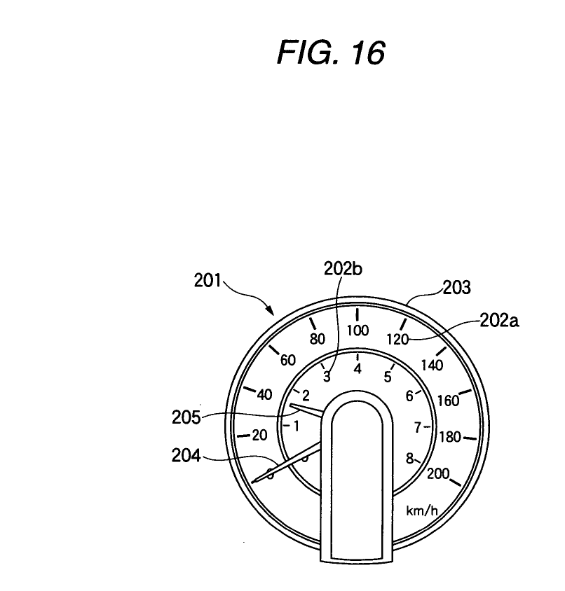

FIG. 12 is a front view of a third embodiment of an automotive meter according to the invention, and FIG. 13 is a front view of a combination meter into which the automotive meter shown in FIG. 12 is incorporated. Note that like reference numerals are given to common portions to those of the automotive meter 110 of the third embodiment, whereby the description thereof will be omitted.

As shown in FIG. 12, a meter 110′ of the third embodiment is formed into a chronograph-like meter by providing further gauges which indicate measured amounts which are different from first and second measured amounts on the stationary portion 111 of the dial of the meter 110 of the second embodiment that has been described above.

For example, a fuel gauge 161 which indicates a residual fuel amount and a coolant temperature gauge 162 which indicates the temperature of a coolant are provided on a stationary portion 111′ of a dial of the meter 110′ at a rightward portion and a leftward portion thereon in such a manner as to hold a center of the stationary portion 111′ therebetween.

The fuel gauge 161 has a circular indication area 163 which is provided as a recessed portion on the stationary portion 111′ of the dial and a pointer 164 which rotates on the indication area 163. A third indication design is provided on the indication area 163 which indicates a residual fuel amount, and the pointer 164 indicates a position on the third indication design which corresponds to a residual fuel amount then to thereby indicated the residual fuel amount. A driving device which drives the pointer 164 is accommodated within a case 115 (refer to FIG. 11) in such a manner as to be disposed on a rearward side of the dial as in the case with the driving device which drives the pointer 114.

Similarly, the coolant temperature gauge 162 has a circular indication area 165 which is provided as a recessed portion on the stationary portion 111′ of the dial and a pointer 166 which rotates on the indication area 165. A fourth indication design is provided on the indication area 165 which indicates the temperature of a coolant, and the pointer 166 indicates a position on the fourth indication design which corresponds to a coolant temperature then to thereby indicated the temperature of the coolant. A driving device which drives the pointer 166 is accommodated within the case 115 (refer to FIG. 11) in such a manner as to be disposed on the rearward side of the dial as in the case with the driving device which drives the pointer 114.

According to the automotive meter 110′ configured as has just been described above, the space occupied thereby can be reduced further, whereby as shown in FIG. 13, in a combination meter 170 into which the automotive meter 110′ is incorporated, large spaces can be allocated where multi-displays 171, 172 are to be disposed, respectively.

Note that the invention is not limited to the embodiments that have been described heretofore but can be modified and improved as appropriately.

For example, in the automotive meter 110 of the second embodiment, while the first and second indication designs 118a, 118b are described as indicating running speed and engine speed in revolution, respectively, the invention is not limited thereto, and they can be combined with the gauges which indicate residual fuel amount and coolant temperature as appropriately.

In addition, in the automotive meter 110 of the second embodiment, while the disc-shaped portion of the dial is configured as the stationary portion 111 and the circular ring-shaped portion of the dial which becomes concentric with the stationary portion 111 on the outer circumferential side of the stationary portion 111 is configured as the movable portion 112, the disc-shaped portion of the dial may be configured as the movable portion, whereas the circular ring-shaped portion may be configured as the stationary portion. However, by comparing the first and second measured amounts that are indicated to each other, the indication design which corresponds to the measured amount of higher importance is preferably provided on the stationary portion. For example, in the automotive meter 110 of the second embodiment, while the running speed and the engine speed are indicated, the indication design corresponding to the running speed which is of higher importance is provided on the stationary portion as the first indication design 118a.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2005-030491 filed on Feb. 7, 2005 and Japan Patent Application No. 2005-030799 filed on Feb. 7, 2005, the contents of which are incorporated herein for reference.

What is claimed is:

1. A speedometer for a vehicle, comprising:
a display part formed into a circular shape and that includes a movable portion rotatable about a center thereof, the movable portion having an indication design; and
a pointer that rotates to indicate the indication design for displaying the running speed of the vehicle,
wherein during a normal driving, the pointer rotates to indicate a position on the indication design of the movable portion that corresponds to a current running speed of the vehicle while the movable portion is fixed; and
wherein during a driving with an adaptive cruse control system, the movable portion rotates so that the pointer indicates a position on the indication design of the movable portion that corresponds to the current running speed of the vehicle while the pointer is fixed.

2. The speedometer as set forth in claim 1, wherein the pointer is fixed in a state that the pointer is directed perpendicularly upwardly during the driving with the adaptive cruse control system.

3. A combination meter, comprising the speedometer set froth in claim 1.

4. A meter for a vehicle, comprising:
a display part that includes:
a stationary portion having a first indication design for a first measured amount associated with a state of the vehicle; and
a movable portion having a second indication design for a second measured amount associated with the state of the vehicle, the movable portion disposed concentrically with the stationary portion and adapted to rotate about a center of the stationary portion; and
a pointer that rotates to indicate a position on the first indication design of the stationary portion that corresponds to the first measured amount,
wherein the movable portion rotates so that the pointer indicates a position on the second indication design of the movable portion that corresponds to the second measured amount; and
wherein the second measured amount is different from the first measured amount.

5. The meter as set forth in claim 1, wherein a gauge is provided on the stationary portion; and
wherein the gauge displays a third measured amount associated with the state of the vehicle that is different from the first and second measured amount.

6. A combination meter, comprising the meter set forth in claim 4.
